(19) United States
(12) Patent Application Publication
(10) Pub. No.: US 2005/0011352 A1
(43) Pub. Date: Jan. 20, 2005

(54) Air regulator

(76) Inventor: Carl J. Bonta JR., Elgin, IL (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 10/885,178

(22) Filed: Jul. 6, 2004

Related U.S. Application Data
(60) Provisional application No. 60/486,942, filed on Jul. 14, 2003.

(51) Int. Cl. G05D 11/00

(52) U.S. Cl. 91/418

(57) ABSTRACT

A single stage regulator is disclosed wherein a cartridge valve, and built in accumulator configuration are utilized to regulate an input or supply pressure such as about 5,000 PSI, to an output or delivery pressure range from about 50 to about 150 PSI. The single stage regulator can be used in the construction and mechanical assembly industries. The regulator can power such devices as pneumatic nailing equipment, impact wenches, and other air driven devices.

### RELATED APPLICATIONS

This application claims the benefit of U.S. Provisional Application Ser. No. 60/486,942, filed on Jul. 14, 2003, and herein incorporated by reference. This application also claims the benefit of U.S. Provisional Application Ser. No. ______ (To Be Determined), having attorney docket no. 5709 P006, filed concurrently with this application, and herein incorporated by reference.

### TECHNICAL FIELD

The present invention relates to a regulator apparatus and method for regulating the output delivery pressure from a pressure vessel or the like.

### SUMMARY OF THE INVENTION

A single stage regulator is disclosed wherein a cartridge valve and built-in accumulator configuration are utilized to regulate an input or supply pressure as high as about 5,000 PSI, to an output or delivery pressure in an adjustable range from about 50 PSI to about 150 PSI. As an example, and without limitation thereto, the single stage regulator can be used in the construction and mechanical assembly industries. The regulator can be used to power devices such as pneumatic nailing equipment, impact wrenches, and other air driven devices.

Other features and advantages of the invention will be apparent from the following specification taken in conjunction with the following drawings.

### BRIEF DESCRIPTION OF THE DRAWINGS

FIG. 1 is an elevation view of an adjusting knob for a regulator in accordance with the present invention;

FIG. 2 is a top view of the adjusting knob of FIG. 1;

FIG. 3 is a bottom view of the adjusting knob of FIG. 1;

FIG. 4 is a side elevation view of an output or delivery pressure adjustment shaft for a regulator in accordance with the present invention;

FIG. 5 is an end view of the adjustment shaft of FIG. 4;

FIG. 6 is a cross sectional side elevation view of a regulator body for a regulator in accordance with the present invention;

FIG. 7 is a side elevation view of the regulator body of FIG. 6, wherein cavities and passages within the regulator are depicted with broken lines;

FIG. 8 is an end view of the regulator body of FIG. 7;

FIG. 9 is an opposite end view, from that shown in FIG. 8, of the regulator body of FIG. 7;

FIG. 10 is an extrusion profile of the regulator body of FIGS. 6-9;

FIGS. 11-12 are side elevation views of a regulator cap for a regulator in accordance with the present invention, wherein cavities and passages within the regulator cap are depicted with broken lines;

FIG. 13 is a bottom view of the regulator cap of FIGS. 11-12;

FIG. 14 is a top view of the regulator cap of FIGS. 11 and 12, wherein cavities and passages within the regulator are depicted with broken lines;

FIG. 15 depicts various measurements for the regulator cap of FIGS. 11-14;

FIG. 16 depicts a cross sectional side elevation view of a piston for a regulator in accordance with the present invention;

FIG. 17 depicts a side elevation view of the piston of FIG. 16, wherein passages within the piston are depicted with broken lines;

FIG. 18 depicts an end view of the piston of FIGS. 16-17;

FIG. 19 depicts an opposite end view, from that shown in FIG. 18, of the piston of FIGS. 16-17;

FIG. 20 is a cross sectional side elevation view of another embodiment of a piston for a regulator in accordance with the present invention;

FIG. 21 depicts a side elevation view of the piston of FIG. 20, wherein passages within the piston are depicted with broken lines;

FIG. 22 depicts an end view of the piston of FIGS. 20-21;

FIG. 23 depicts an opposite end view, from that shown in FIG. 22, of the piston of FIGS. 20-21;

FIG. 24 is a cross sectional side elevation view of a vessel or bottle adaptor in accordance with the present invention;

FIG. 25 depicts a side elevation view of the vessel or bottle adaptor of FIG. 24, wherein passages within the adaptor are depicted with broken lines;

FIG. 26 depicts an end view of the bottle adaptor of FIG. 25;

FIG. 27 depicts an opposite end view, from that shown in FIG. 26, of the bottle adaptor of FIG. 25;

FIGS. 28-30 depict various views of an alternative embodiment of a regulator main body in accordance with the present invention, wherein the regulator main body has an accumulator that accumulates oil or the like;

FIGS. 31-34 depict various views of an end or regulator body cap for use with the regulator main body of FIGS. 28-30;

FIG. 35 depicts a cosmetic cut profile view of the regulator body cap of FIGS. 31-34;

FIGS. 36-39 depict various views of a high pressure piston for use with the regulator main body of FIGS. 28-30;

FIGS. 40-42 depict various views of an low pressure adjuster knob for use with the regulator main body of FIGS. 28-30;

FIGS. 43-45 depict various views of a high pressure valve pin for use with the regulator main body of FIGS. 28-30;

FIGS. 46-47 depict various views of an oiler piston for use with the regulator main body of FIGS. 28-30;

FIGS. 48-49 depict various views of a gauge adapter for use with the regulator main body of FIGS. 28-30;

FIGS. 50-54 depict various views of an oil fill nipple for use with the regulator main body of FIGS. 28-30;

FIGS. 55-57 depict various views of an oil fill strut for use with the regulator main body of FIGS. 28-30;

FIGS. 58-61 depict various views of an on/off rotary valve for use with the regulator main body of FIGS. 28-30;

FIGS. 62-63 depict various views of a shoulder screw for use with the regulator main body of FIGS. 28-30;

FIGS. 64-66 depict various views of a high pressure adjuster for use with the regulator main body of FIGS. 28-30;

FIGS. 67-69 depict a high pressure regulator seat for use with the regulator main body of FIGS. 28-30;

FIGS. 70-72 depict an air fill adapter for use with the regulator main body of FIGS. 28-30; and,

FIGS. 73-75 depict a fill strut for use with the regulator main body of FIGS. 28-30.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

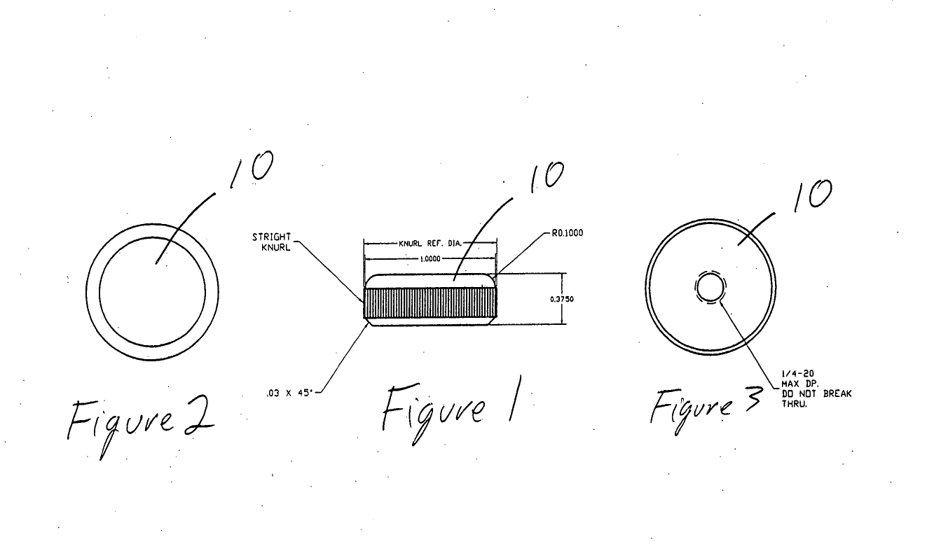

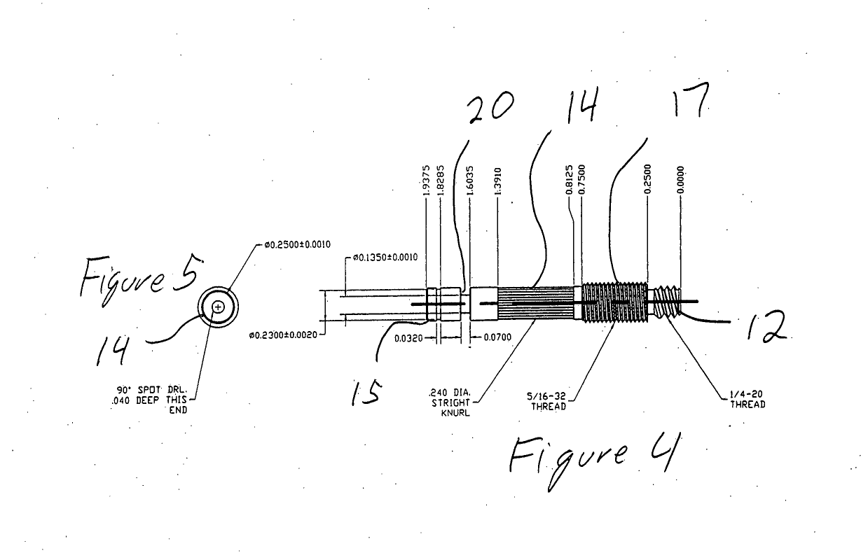

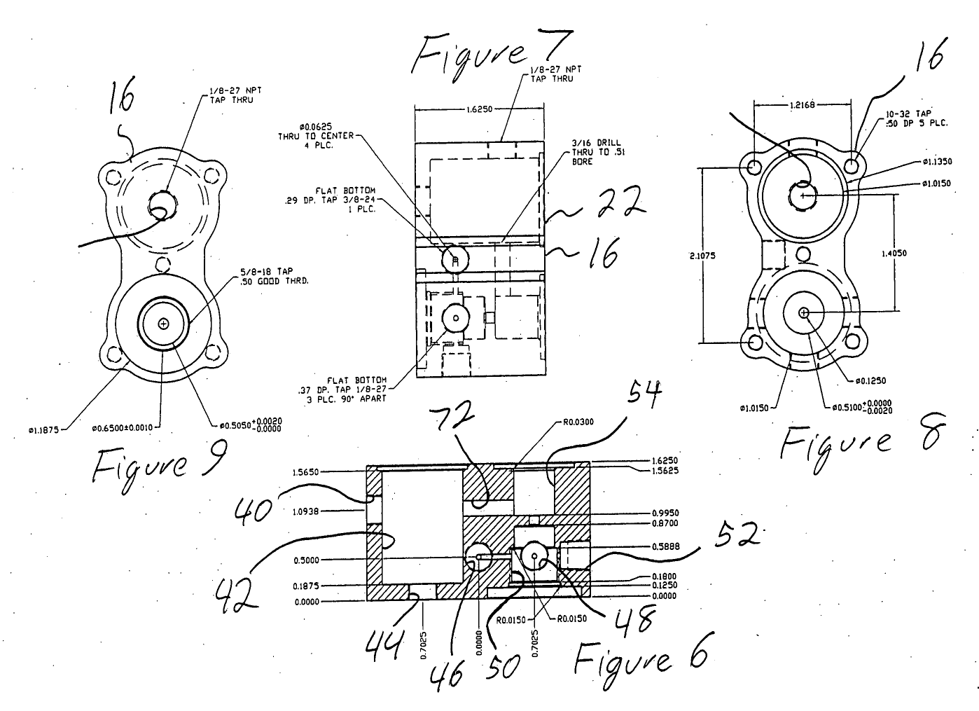

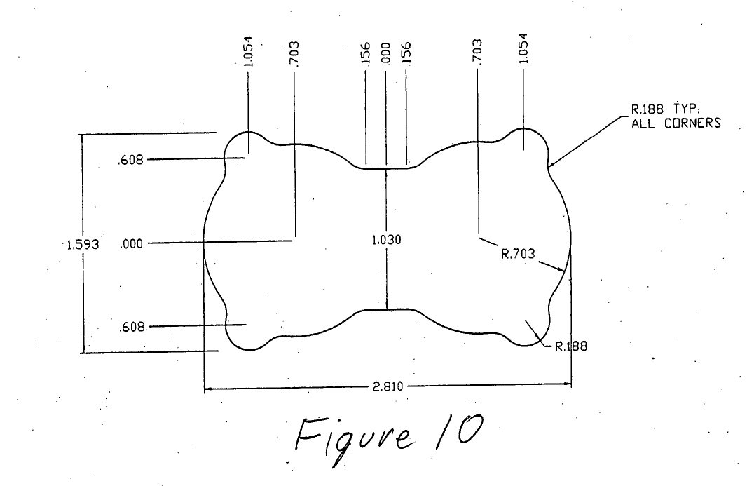

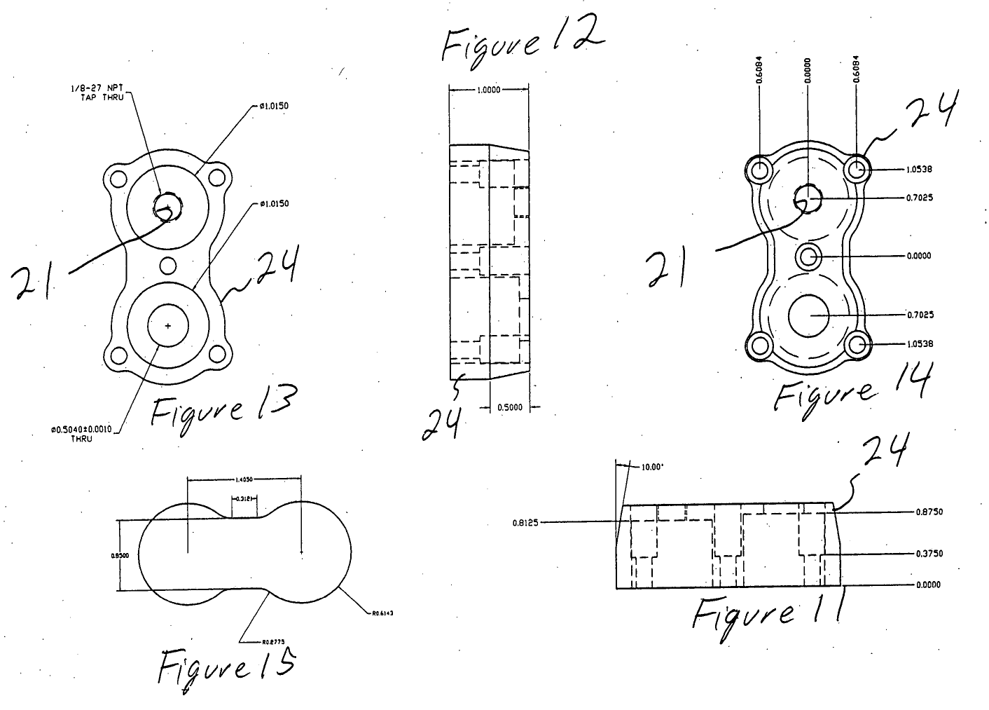

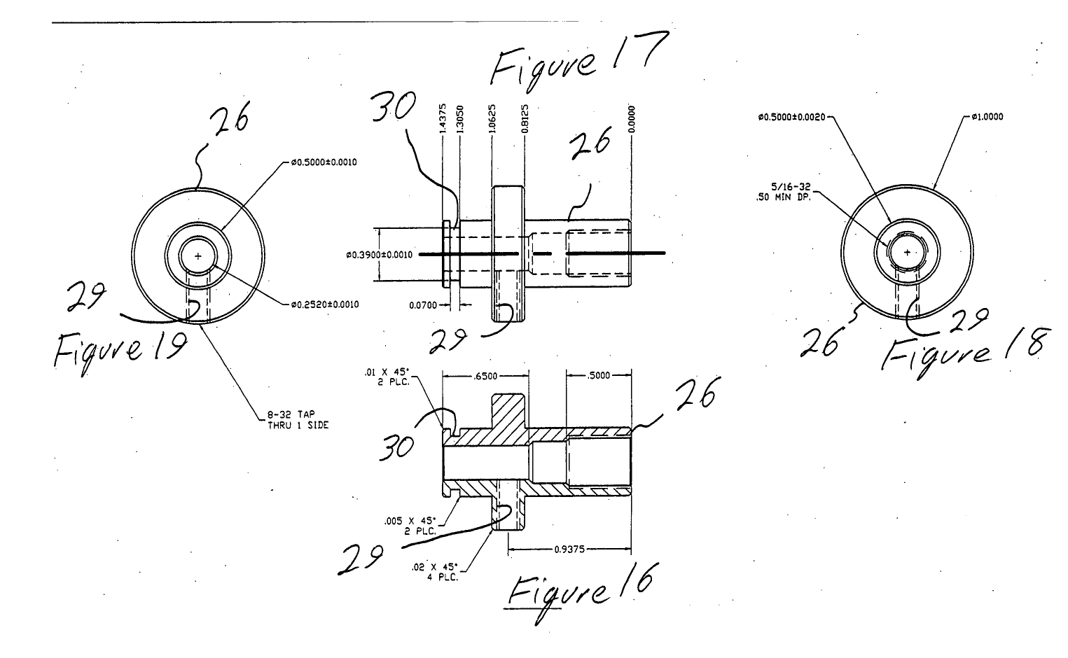

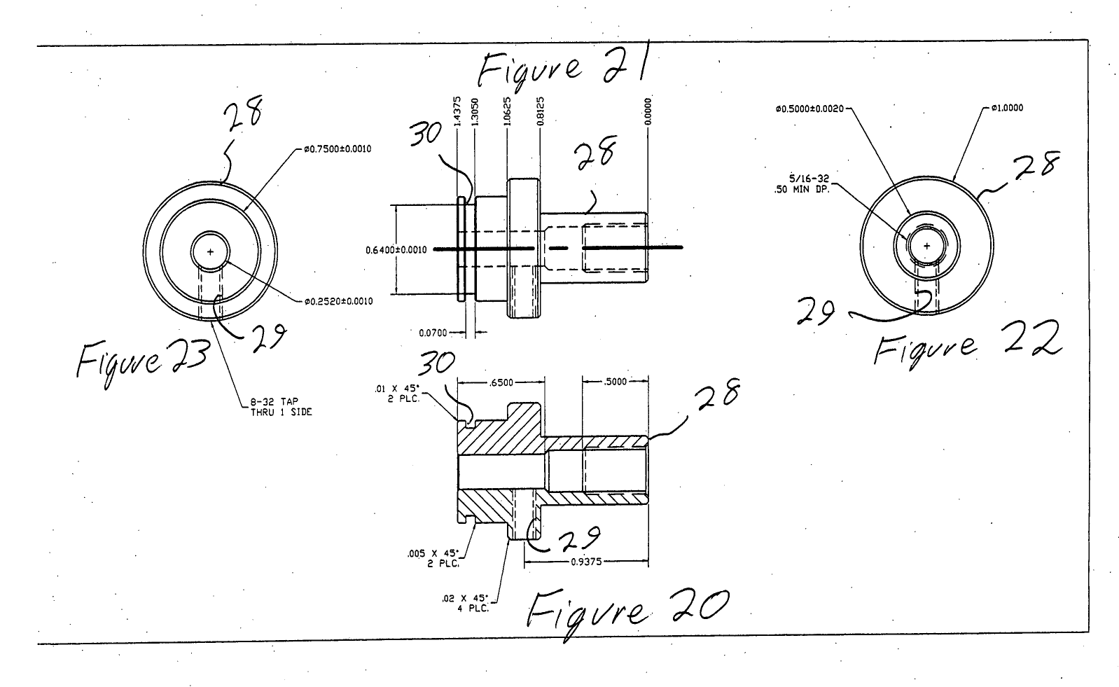

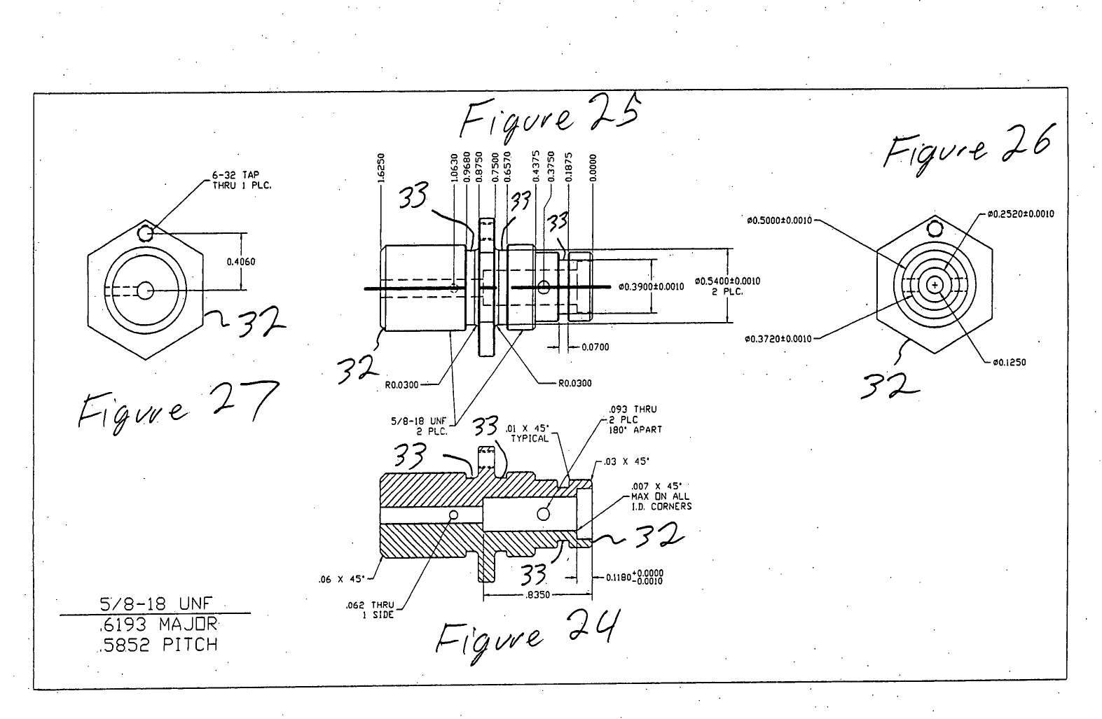

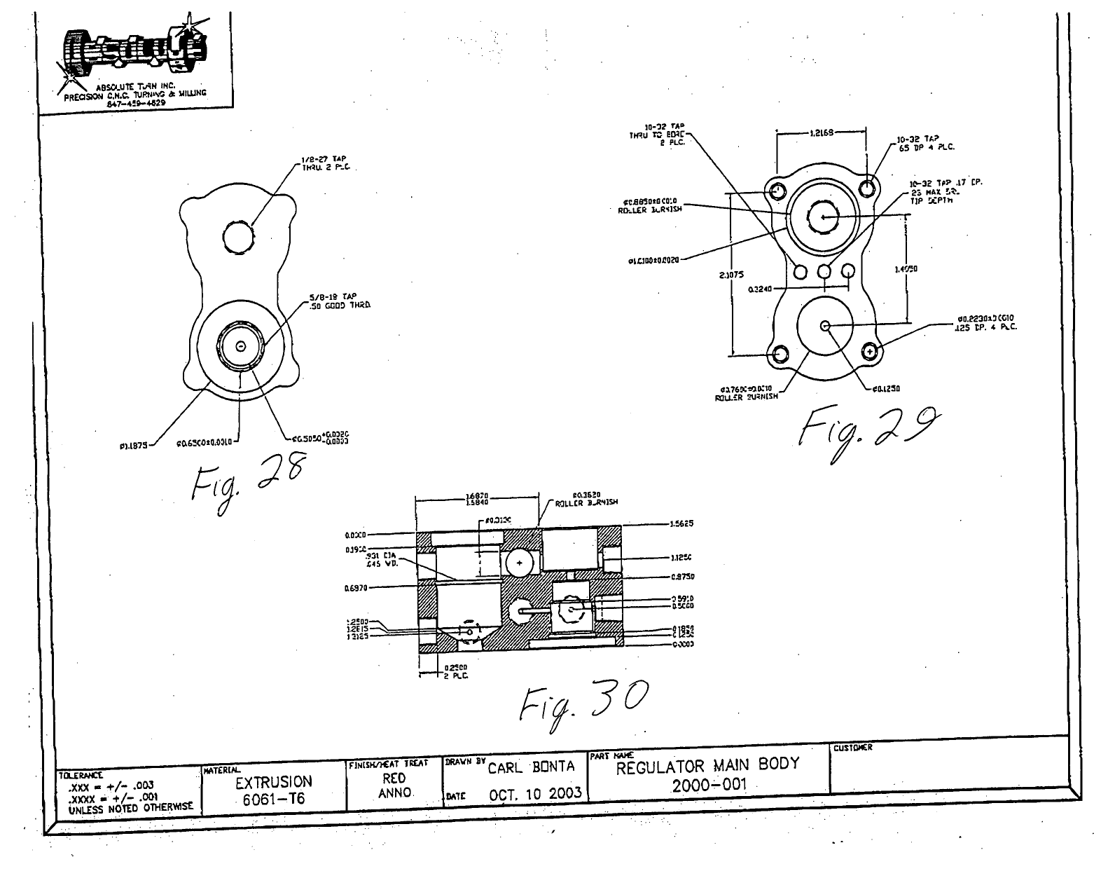

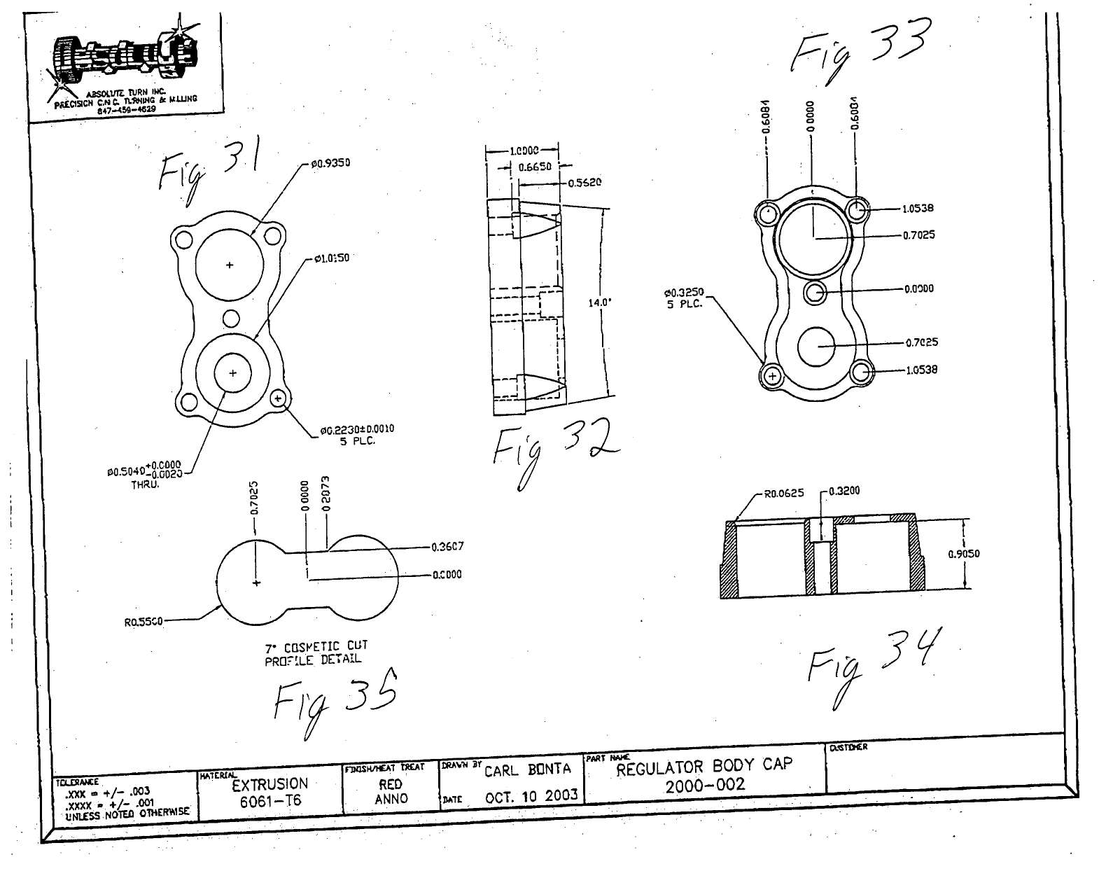

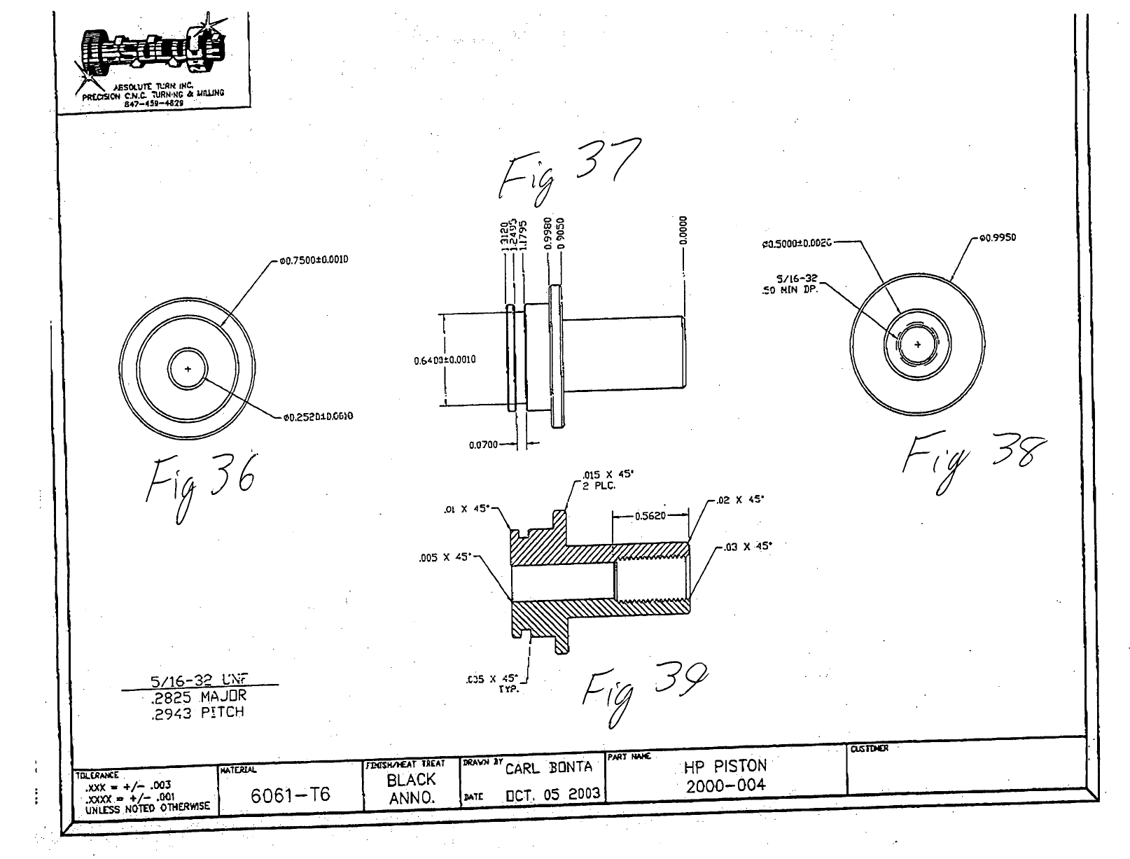

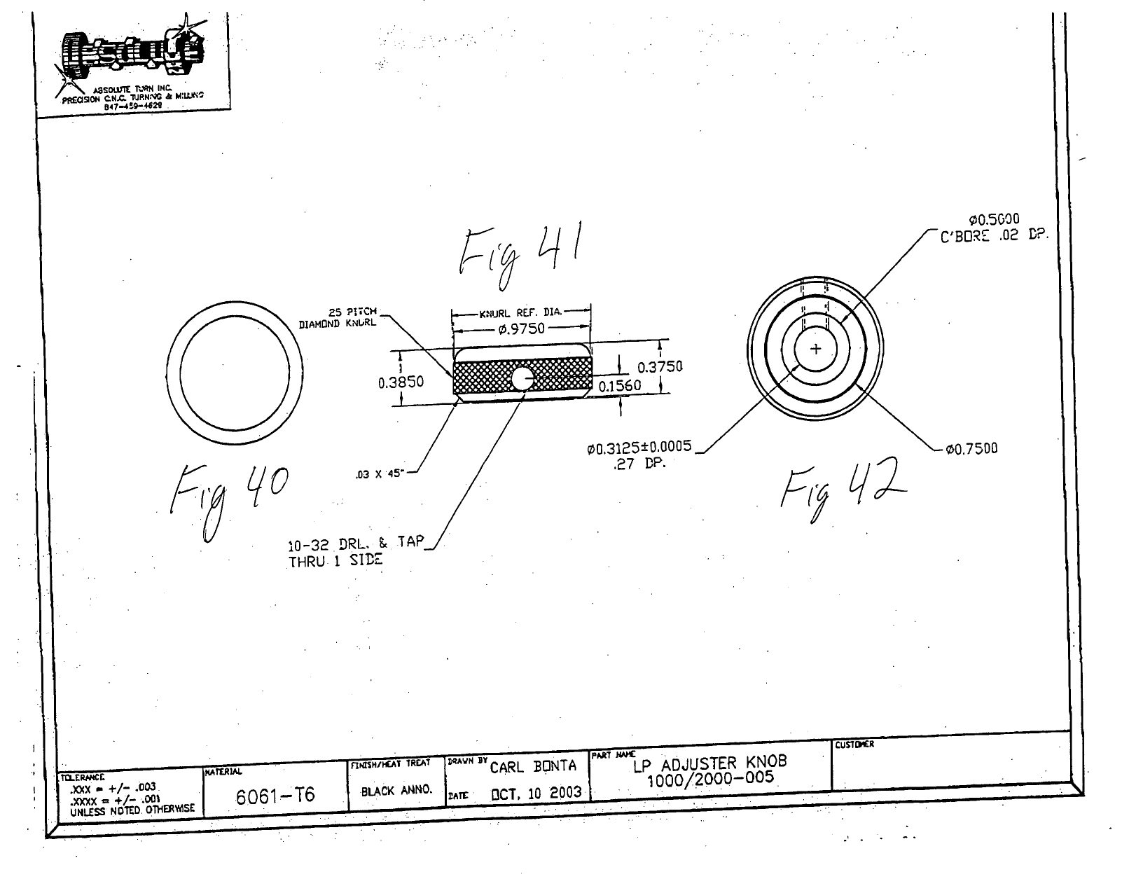

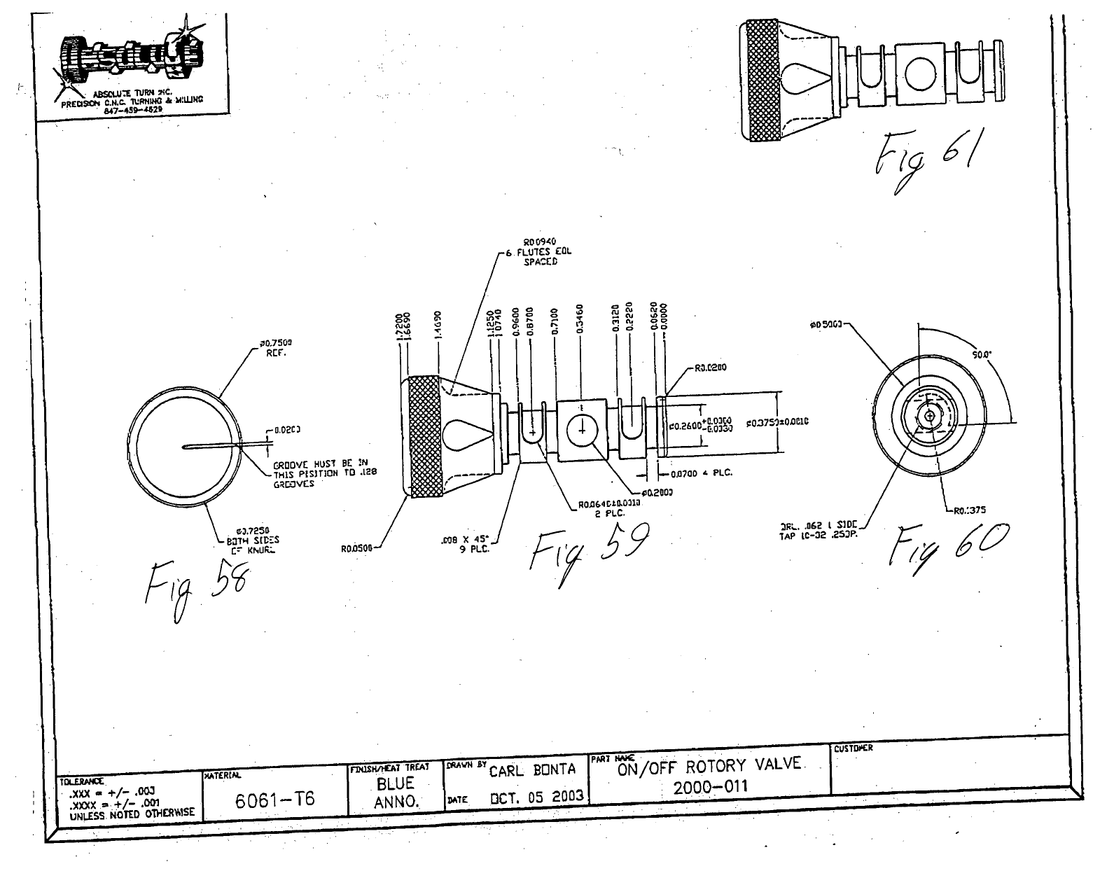

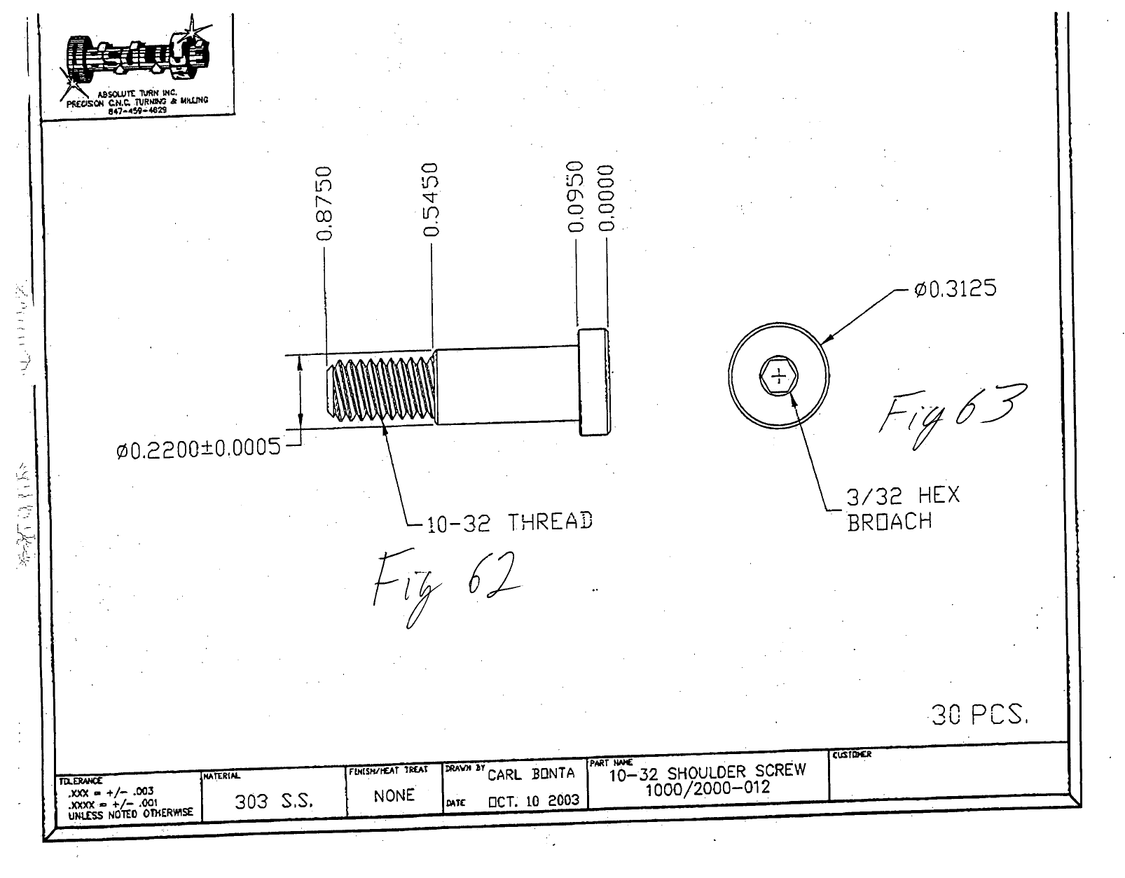

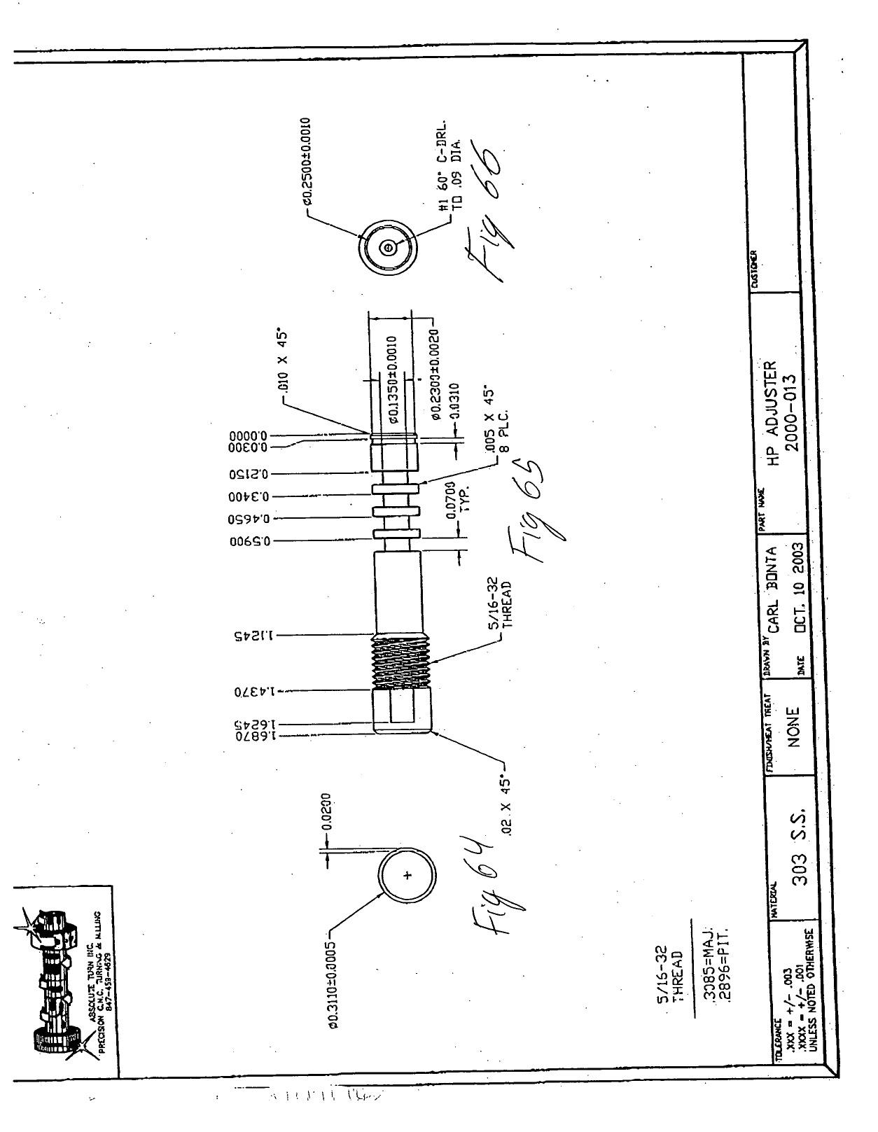

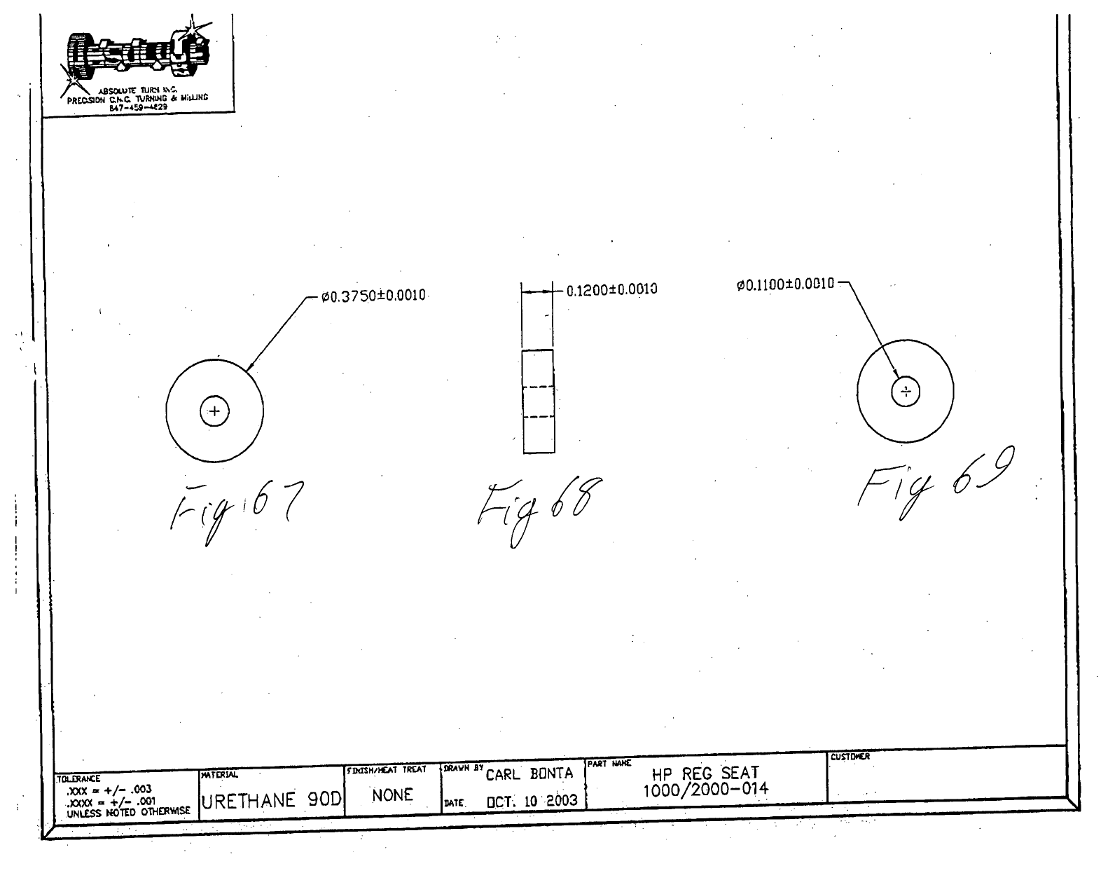

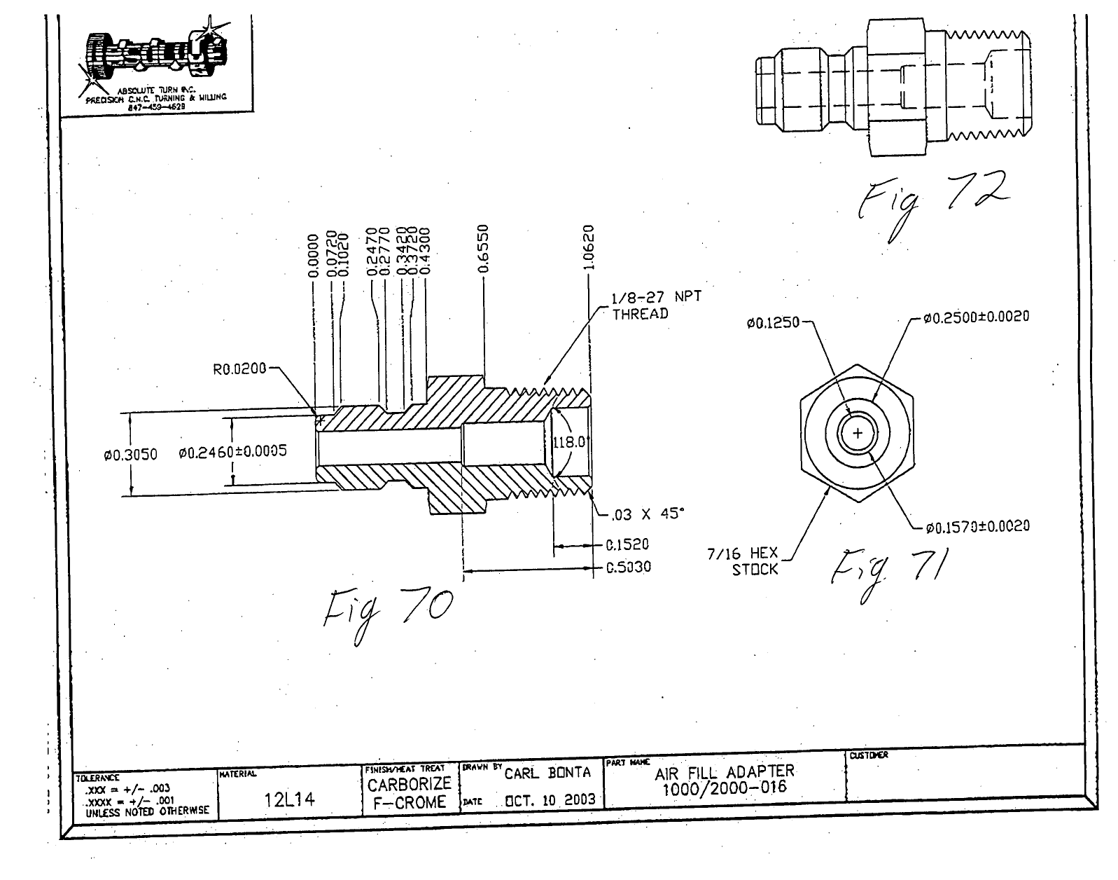

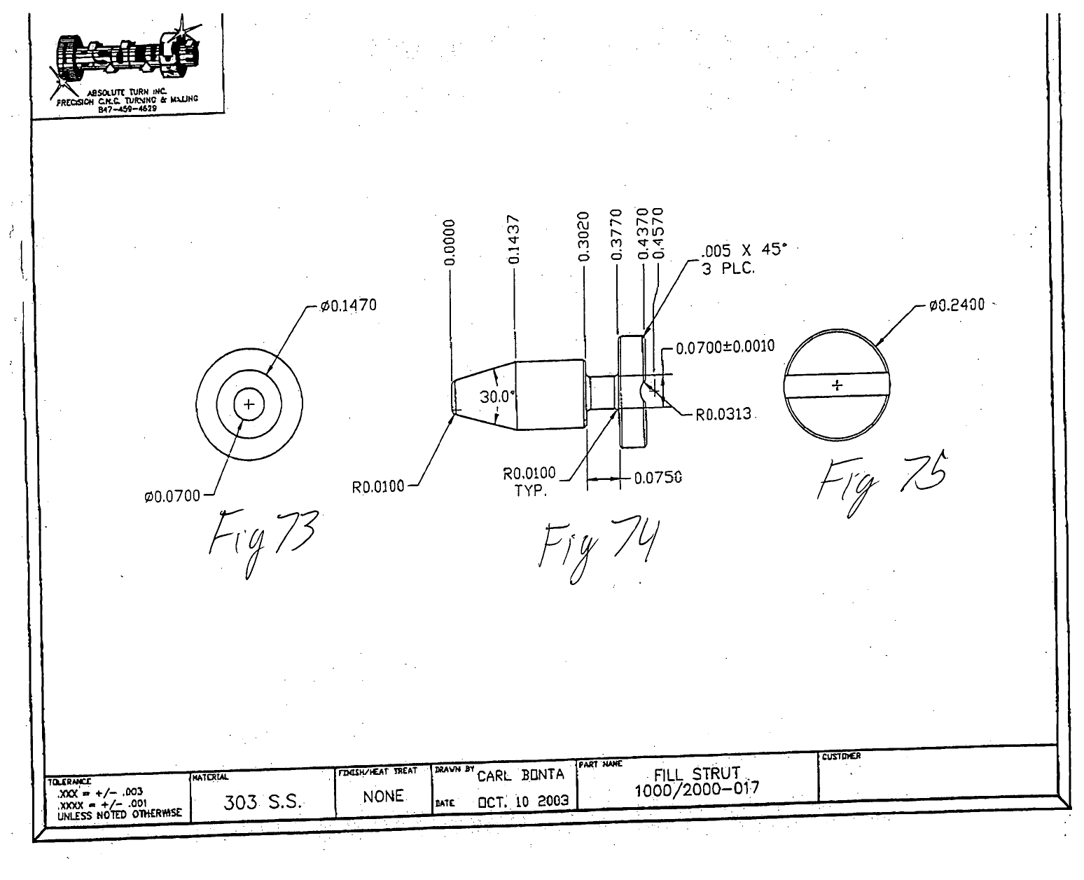

Turning to FIGS. 1-3, an output pressure adjustment knob 10 is depicted. The knob 10 is attached to an end 12 of an output pressure adjustment shaft 14 depicted in FIG. 4. The shaft 14 is installed into a regulator main body 16 depicted in FIGS. 6-9. Preferably, a urethane o-ring (not shown) or the like is mounted about a groove 20 in the shaft 14.

The main body 16 includes a threaded output port 40, and accumulation chamber 42, a threaded safety poppet port 44, a threaded burst disk port 46, a threaded plug fill nipple ports 48 and 52, a threaded bottle adapter port 50, and a piston bore 54.

Attached to a planar end surface 22 of the regulator main body 16 is a regulator cap 24 depicted in FIGS. 11-13. Also, mounted within the piston bore 54 within the regulator main body 16 is a piston 26 as depicted in FIGS. 16-19. Alternatively, the piston 28 as depicted in FIGS. 20-23 is mounted within the piston bore 54 formed within the regulator main body. Preferably, each piston 26 and 28 has a groove 30 with an o-ring (not shown) mounted therein. Moreover, each piston preferably includes a bore 29 with a ball plunger (not shown) installed therein. The ball plunger provides a “ratchet” feel when adjustments or turns are made to the adjustment shaft 14. The “ratchet” feel results from the ball plunger engaging the knurl on the adjustment shaft 14.

Turning to FIGS. 24-26, a vessel or bottle adapter 32 is depicted for attaching and receiving input or supply pressure from a vessel, bottle, or the like. Preferably, urethane o-rings (not shown) or the like are mounted about grooves 33 in the adapter 32. Preferably, all components shown within the FIGURES are made from a metal or metal alloy such as an aluminum alloy.

Turning back to FIGS. 6-9, the output port 40 provides an output for the regulated gas, such as air, provided by the device. Accordingly, the regulated gas, such as air, is stored within the accumulation chamber 42.

In an embodiment, a safety poppet (not shown) is installed within the safety poppet port 44. Preferably, but not necessarily, the poppet releases or vents pressure from the accumulator chamber 42 if the pressure within the chamber exceeds about 200 PSI. The poppet can be the resealing type, wherein pressure is not vented from the accumulator chamber once the pressure within the chamber drops below about 200 PSI.

In an embodiment, a burst disk (not shown) is installed within the burst disk port 46. The burst disk provides for high pressure safety by bursting if the pressure within the input supply port 50 becomes too great. Accordingly, for example, the burst disk will rupture if a gas tank (i.e., gas supply) provides too much supply pressure to the device.

In an embodiment, a pressure gauge (not shown) and fill nipple (not shown) can be installed within the ports 48 and 52. In an embodiment, the pressure gauge provides a pressure reading from about 0 PSI to about 5000 PSI. Moreover, the fill nipple provides for attaching the device to a gas pressure supply such as an air tank.

As will be appreciated by those having ordinary skill in the art, additional ports, similar to ports 48 and 52, can be provided by the device. Preferably, any unused ports are plugged.

In an embodiment, the cartridge or bottle adapter 32 of FIGS. 24-27 is installed within the bottle adapter port 50. The bottle adapter 32 provides for attaching the device to a gas pressure supply such as a gas bottle providing, for example, a pressure of about 5000 PSI or less. The bottle adapter 32 can retain a spring (not shown), valve pin (not shown), and a valve seat (not shown). In an embodiment, the seat is preferably constructed of urethane and has a 3/8 inch outer diameter, 1/8 inch inner diameter, and is 1/8 inch thick. The valve seat can be pressed into the bottle adapter 32, which is installed into the bottle adapter port 50 by compressing the seat and creating a seal.

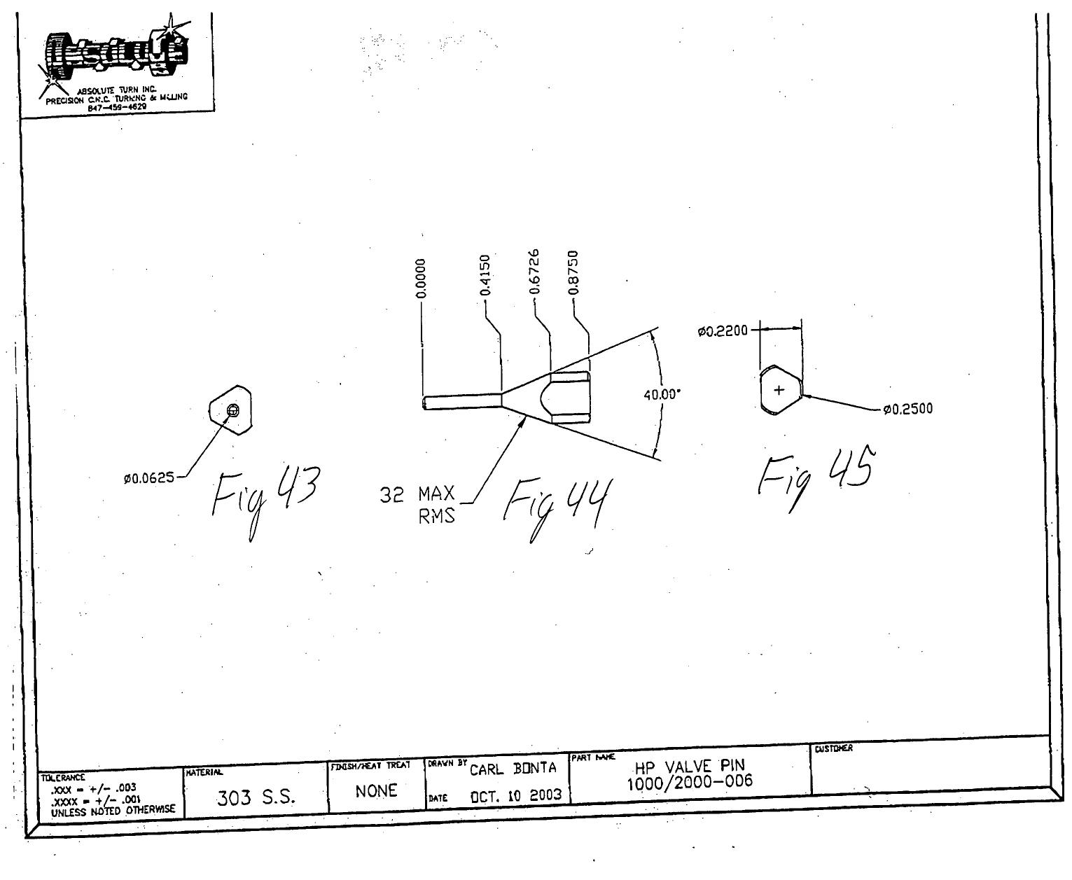

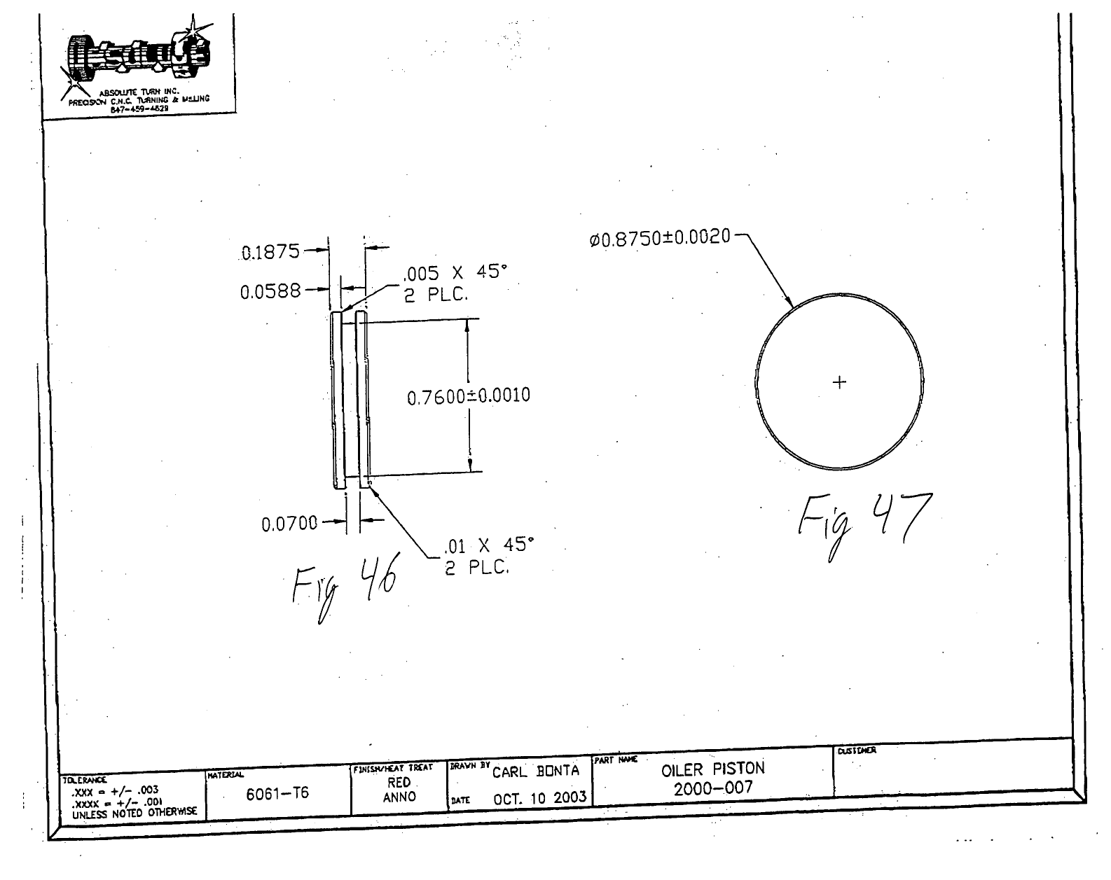

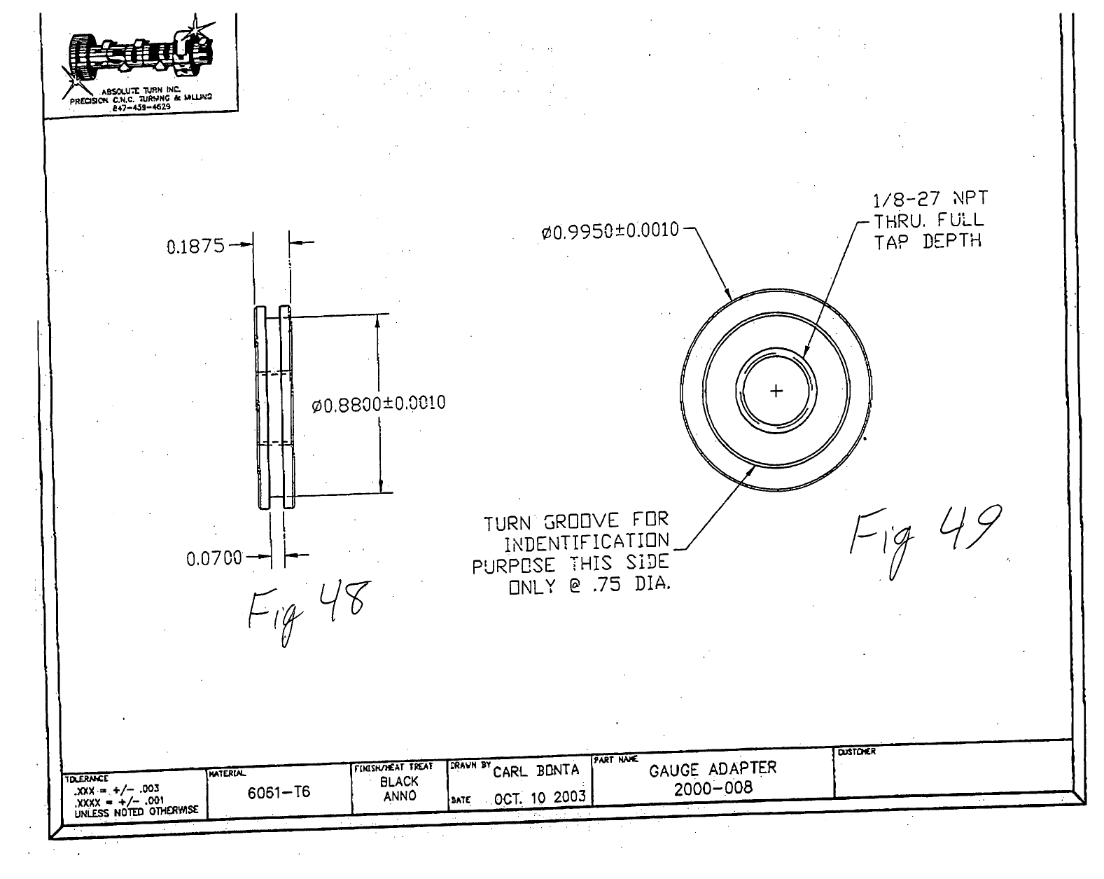

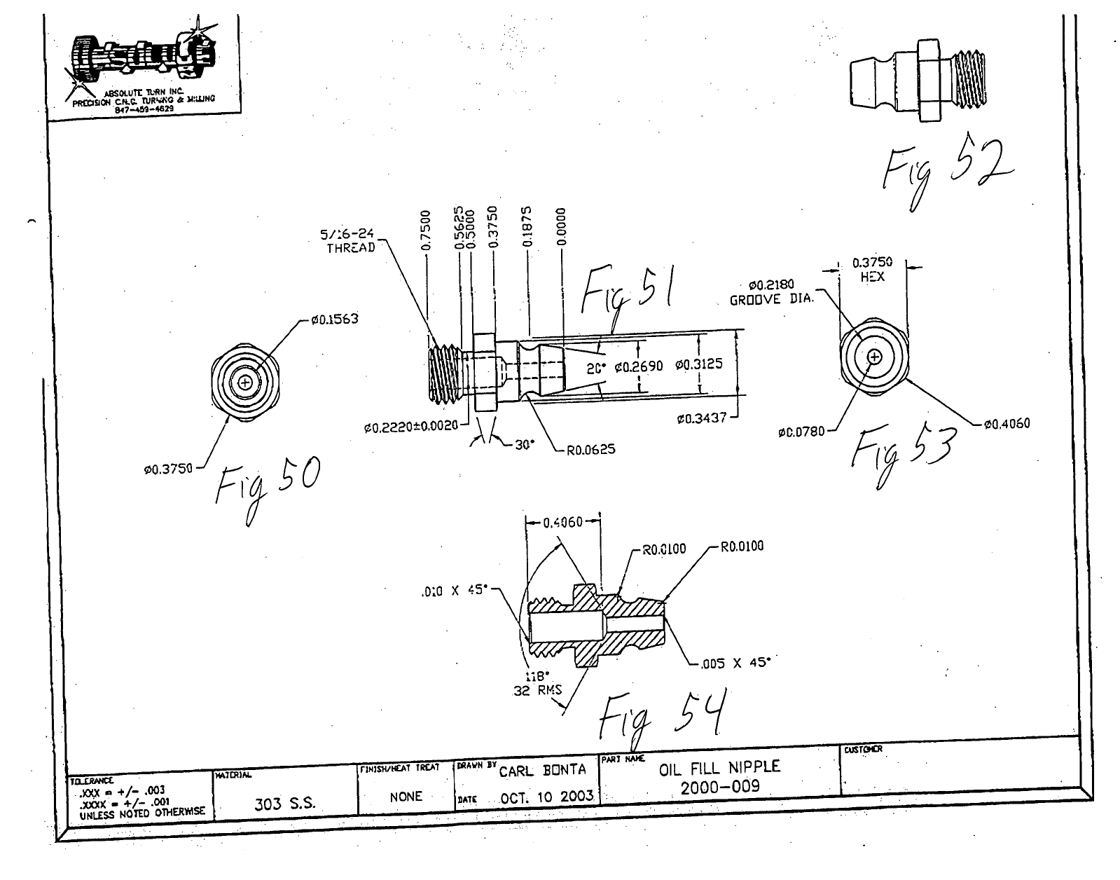

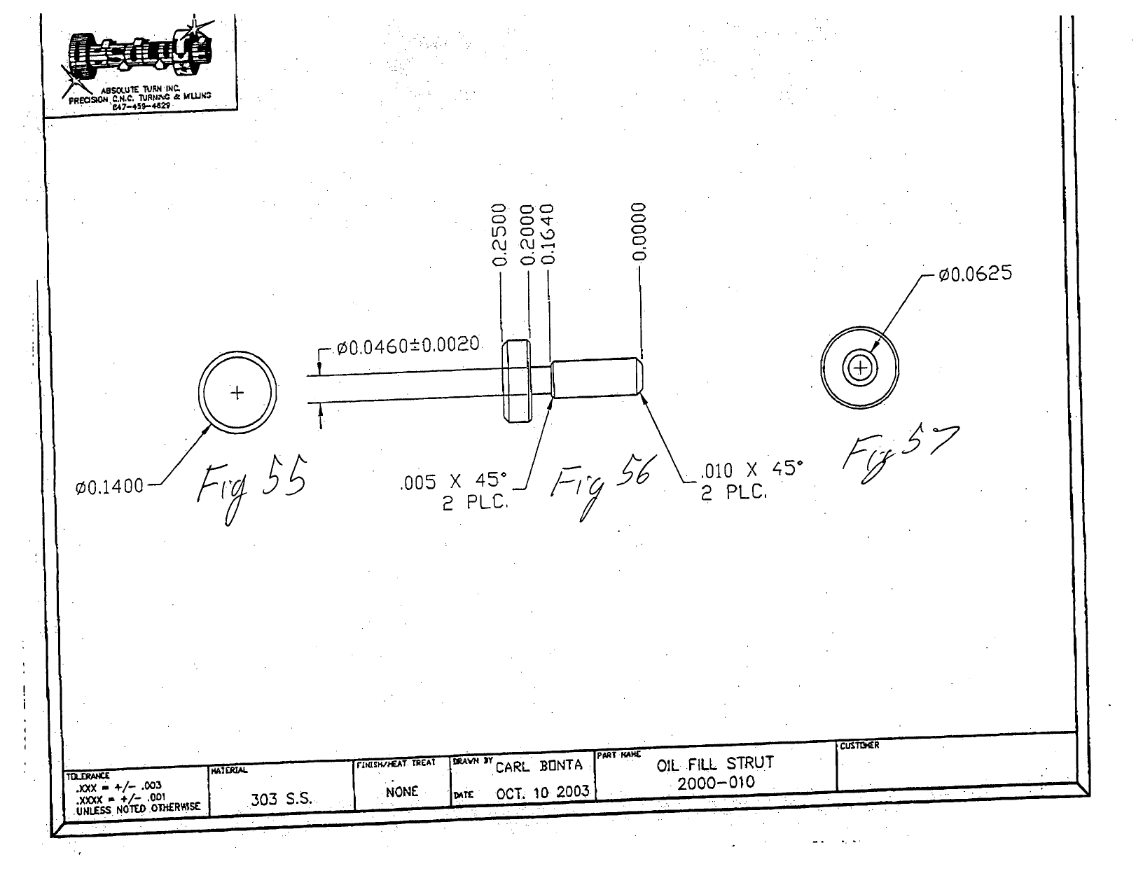

In an embodiment, the piston 26 as shown in FIGS. 16-19, or the piston 28 as shown in FIGS. 20-23, is installed within the piston bore 54. The piston is preferably forced within the bore 54 by a spring (not shown). Moreover, the distal end 15 of the adjustment shaft 14 (FIGS. 4 and 5) is inserted through the bore within the piston. Also, threads 17 about the adjustment shaft 14 engage like threads 21 about a bore in the regulator cap 24.

The adjustment shaft 14, via the piston, pushes on the valve pin (not shown) seated on the valve seat (not shown) wherein, as stated previously, the bottle adapter 32 retains both the valve pin and the valve seat. As the valve pin seated on the valve seat is pushed, it allows high pressure gas into the piston bore 54 opposing the piston and sending the piston up off of the valve pin to thus provide regulated pressure into the accumulator via path 72 from the piston bore 54 to the accumulator chamber 42.

While the specific embodiments have been illustrated and described, numerous modifications come to mind without significantly departing from the spirit of the invention, and the scope of protection is only limited by the scope of the accompanying claims.

1. A regulator having an output pressure and comprising:
a housing comprising a unitary billet regulator body defining an accumulator chamber and a piston chamber;
a piston within the piston chamber; and
an adjustment knob for adjusting the output pressure of the regulator between about 0 PSI and 150 PSI.

2. The regulator of claim 1 wherein a belleview spring is operably coupled to the piston.

3. The regulator of claim 2 wherein a compression spring adjoins the piston.

4. The regulator of claim 1 wherein the regulator is coupled to a nail gun via an air hose.

5. The regulator of claim 1 wherein an end cap is attached to the regulator body.

6. The regulator of claim 1 wherein the regulator receives an input pressure of about 5,000 PSI.

7. The regulator of claim 1 wherein the regulator is coupled to an impact wrench via an air hose.

8. The regulator of claim 1 wherein the regulator regulates air pressure.

9. The regulator of claim 1 wherein the regulator regulates pressure of a gas other than air.

10. An air regulator having an output pressure and comprising:
a housing comprising a unitary regulator body defining an accumulator chamber and a piston chamber, and an end cap is attached to the regulator body;
a piston within the piston chamber; and
an adjustment knob for adjusting the output pressure of the regulator between about 0 PSI and 150 PSI.

11. The regulator of claim 1 wherein a belleview spring is operably coupled to the piston.

12. The regulator of claim 1 wherein a compression spring adjoins the piston.

13. The regulator of claim 1 wherein the regulator is coupled to a nail gun via an air hose.

14. The regulator of claim 1 wherein the regulator receives an input pressure of about 5,000 PSI.

15. The regulator of claim 1 wherein the regulator is coupled to an impact wrench via an air hose

16. An air regulator having an output pressure and comprising:
a housing comprising a unitary regulator body defining an accumulator chamber and a piston chamber, and an end cap is attached to the regulator body, the accumulator configured to receive an input air pressure of about 5,000 PSI;
a piston within the piston chamber; and
an adjustment knob for adjusting the output pressure of the regulator between about 0 PSI and 150 PSI.

17. The regulator of claim 1 wherein a belleview spring is operably coupled to the piston.

18. The regulator of claim 1 wherein a compression spring adjoins the piston.

19. The regulator of claim 1 wherein the regulator is coupled to a nail gun via an air hose.

20. The regulator of claim 1 wherein the regulator is coupled to an impact wrench via an air hose.
